(19) United States
(12) Patent Application Publication
(10) Pub. No.: US 2023/0351180 A1
(43) Pub. Date: Nov. 2, 2023

(54) QUANTIZATION RECOGNITION TRAINING METHOD OF NEURAL NETWORK THAT SUPPLEMENTS LIMITATIONS OF GRADIENT-BASED LEARNING BY ADDING GRADIENT-INDIPENDENT UPDATE

(71) Applicant: MOBILINT INC., Seoul (KR)

(72) Inventor: Youngrock OH, Uiwang-si (KR)

(73) Assignee: MOBILINT INC., Seoul (KR)

(21) Appl. No.: 18/334,460

(22) Filed: Jun. 14, 2023

Related U.S. Application Data
(63) Continuation of application No. PCT/KR2022/008122, filed on May 27, 2022.

(30) Foreign Application Priority Data
Dec. 30, 2021 (KR) 10-2021-0192318

(51) Int. Cl. G06N 3/08

(52) U.S. Cl. CPC G06N 3/08

(57) ABSTRACT

Disclosed is a quantization-aware training method including setting a quantization level ‘l’ and a quantization level ‘u’ to l=−2^{b-1} and u=2^{b-1}−1, and setting a value ‘k’ to 1, calculating a quantized value \hat{x} as

$$\hat{x} = round ( clamp ( \frac{x}{s} , l , u ) )$$

performing partial differentiation

$$\frac{\partial L}{\partial \hat{x}}$$

of a loss function ‘L’ with the \hat{x} by using straight-through estimation for calculating a gradient of a quantization function during backpropagation, calculating

$$\frac{\partial \hat{x}}{\partial s}$$

by, when the

$$\frac{x}{s}$$

is a value between the quantization level ‘l’ and the quantization level ‘u’, calculating the

$$\frac{\partial \hat{x}}{\partial s}$$

as

$$- \frac{x}{s} + round ( \frac{x}{s} ) ,$$

and, when the

$$\frac{x}{s}$$

is not a value between the quantization level ‘l’ and the quantization level ‘u’, determining the

$$\frac{\partial \hat{x}}{\partial s}$$

as the quantization level ‘l’ when the

$$\frac{x}{s}$$

is less than ‘l’, and determining

$$\frac{\partial \hat{x}}{\partial s}$$

as the quantization level ‘u’ when the

$$\frac{x}{s}$$

is greater than ‘u’, updating the ‘x’ to

$$x + g ( \begin{matrix}\partial L \\ \partial x\end{matrix} ) ,$$

updating ‘s’ to

$$s + g ( \begin{matrix}\partial L \\ \partial s\end{matrix} ) ,$$

and updating ‘n’ to ‘n+1’, when

$$“ l < \frac{x}{s} < u ”$$

is satisfied, updating a gradient-independent quantization step ‘s’ to “s−β(s−sₘᵢₙ).

### CROSS-REFERENCE TO RELATED APPLICATIONS

The present application is a continuation of International Patent Application No. PCT/KR2022/008122, filed on May 27, 2022, which is based upon and claims the benefit of priority to Korean Patent Application No. 10-2021-0192318 filed on Dec. 30, 2021. The disclosures of the above-listed applications are hereby incorporated by reference herein in their entirety.

### BACKGROUND

Embodiments of the inventive concept described herein relate to a quantization recognition training method of a neural network that supplements the limitations of gradient-based learning by adding a gradient-independent update.

As a technology for accelerating hardware in a computing system, a hardware accelerator is used to process a large amount of complex operations in a fast time instead of a central processing unit (CPU). For example, instead of the CPU, several hardware accelerators are being used, such as a graphic processing unit (GPU) that provides hardware acceleration specialized for graphic operations, and a neural processing unit (NPU) that provides hardware acceleration specialized for deep learning model operations.

Edge devices (terminals) often have limited memory or computational power when calculating deep learning models. Even within these constraints, various model optimization techniques are being applied to quickly perform deep learning operations. Moreover, special hardware may be used to accelerate inference operations through these optimization techniques. Generally, as the size of a model decreases, the storage space occupied by a user's device is reduced, and the time and bandwidth required to download to the user's device is further reduced. As the model decreases, the capacity of RAM decreases during an operation. Accordingly, optimization is required in a deep learning model in that more memory capable of being used in another part of an application may be further secured, and performance and stability may be improved.

In particular, an edge accelerator device such as an automotive neural processing unit (NPU) requires low power and high performance, and has a very important factor of improving system efficiency by reducing the amount of calculation.

Among various optimization techniques for deep learning model operations, quantization is widely used. A partial optimization form may reduce the amount of computation required to run inference using a model, and thus latency, which is a time required to run a single inference with a given model, may be reduced. This delay time may also affect power consumption of a user device.

Quantization may be used to reduce latency and power consumption in a method of potentially reducing accuracy by simplifying the computations that occur during inference. In detail, the quantization reduces the precision of numbers used to represent weights and activation function values or input values of a given model, thereby reducing a model size and speeding up calculations in the inference or training process. For example, the quantization may contribute to reducing the operation cost of the corresponding node by converting the weight of the node expressed in 32-bit floating point into an 8-bit integer.

The quantization techniques that are mainly used are toughly divided into two techniques: post-training quantization (PTQ) and quantization-aware training (QAT) techniques. The PTQ is a technique in which quantization is performed while training is completed in a method of performing training with a floating point model and then quantizing the result weight values. On the other hand, the QAT is a technique capable of reducing the model performance degradation due to quantization, by considering changes that will occur when quantization is performed in a training process of a model in advance through fake quantization. The QAT costs more than PTQ because the QAT is accompanied by model training. However, the quantized model having higher performance may be generally obtained.

For example, it is known that the following types of PTQ and QAT techniques are being used in TensorFlow Lite that is open-source software for machine learning.

TABLE 1

| | Data | Size | | Hardware |
|---|---|---|---|---|
| Technology | requirements | reduction | Accuracy | Supported |
| PTQ of float16 | There is no | Up to 50% | Minor | CPU, GPU |
| | data | | accuracy | |
| | | | loss | |
| PTQ of | There is no | Up to 75% | Accuracy | CPU, GPU |
| dynamic range | data | | loss | (Android) |
| PTQ of integer | Representative | Up to 75% | Reduce | CPU, GPU |
| | unlabeled | | loss of | (Android), |
| | sample | | accuracy. | Edge TPU, |
| | | | | Hexagon DSP |
| Quantization- | Labeled | Up to 75% | Minimal | CPU, GPU |
| aware Training | training data | | accuracy | (Android), |
| (QAT) | | | loss | Edge TPU, |
| | | | | Hexagon DSP |

### SUMMARY

Network quantization aims to reduce the bit-width of network parameters while maintaining the performance of a full-precision network. Conventional QAT methods are effective for learning quantized networks having a fixed quantization step size. However, there are limitations in learning the quantization step size. This is because it is difficult to backpropagate a gradient for the quantization step size of an objective function. Detailed descriptions will be described below. Basically, to train a quantized model, the non-differentiable quantization function needs to be replaced with a differentiable function in a backpropagation process. For example, in a case of a straight-through estimator (STE) that is one of the most widely used QAT techniques, the training is performed by replacing a rounding function with an identity function in the backpropagation process. However, the quantized weight is capable of having a very large change in a value even with a small change in the quantization step size. Accordingly, it is difficult to approximate accurately with a differentiable function, and using only the gradient obtained by approximation may lead to unstable training.

According to an embodiment, a quantization-aware training (QAT) method includes setting a quantization level ‘l’ and a quantization level ‘u’ to l=−2^{b-1} and u=−2^{b-1}, and setting a value ‘k’ to 1, the quantization level ‘l’ being a minimum value of a quantization function, and the quantization level ‘u’ being a maximum value of the quantization function, calculating a quantized value \hat{x} as \hat{x}=round(clamp

$$( \frac{x}{s} , l , u ) ) ,$$

the ‘s’ being an initial quantization step, and the ‘x’ being target data to be quantized, performing partial differentiation

$$\frac{\partial L}{\partial \hat{x}}$$

of a loss function ‘L’ with the \hat{x} by using straight-through estimation (STE) for calculating a gradient of a quantization function during backpropagation, calculating

$$\frac{\partial \hat{x}}{\partial s} ,$$

the calculating

$$\frac{\partial \hat{x}}{\partial s}$$

including, when the

$$\frac{x}{s}$$

is a value between the quantization level ‘l’ and the quantization level ‘u’, calculating the

$$\frac{\partial \hat{x}}{\partial s}$$

as

$$- \frac{x}{s} + round ( \frac{x}{s} ) ,$$

and, when the

$$\frac{x}{s}$$

is not a value between the quantization level ‘l’ and the quantization level ‘u’, determining the

$$\frac{\partial \hat{x}}{\partial s}$$

as the quantization level ‘l’ when the

$$\frac{x}{s}$$

is less than ‘l’, and determining

$$\frac{\partial \hat{x}}{\partial s}$$

as the quantization level ‘u’ when the

$$\frac{x}{s}$$

is greater than ‘u’, updating the ‘x’ to

$$x + g ( \begin{matrix}\partial L \\ \partial x\end{matrix} ) ,$$

updating ‘s’ to

$$s + g ( \begin{matrix}\partial L \\ \partial s\end{matrix} ) ,$$

and updating ‘n’ to ‘n+1’, determining whether

$$“ l < \frac{x}{s} < u ”$$

is satisfied, and updating a gradient-independent quantization step ‘s’ to s−β(s−sₘᵢₙ) when

$$“ l < \frac{x}{s} < u ”$$

is satisfied. An initial value of the β is a hyperparameter, and the β is determined through reinforcement learning. The sₘᵢₙ is a hyperparameter.

In an embodiment, the QAT method further includes determining whether the value ‘k’ is equal to a value Nₐ, wherein the Nₐ is a learning hyperparameter, calculating a reward function ‘R’, and initializing the ‘k’ to 1. The reward function ‘R’ is determined to represent performance when learning is performed by using the β. The reward function ‘R’ is defined as an average of the loss function ‘L’ calculated during Nₐ updates, a difference between weights before and after quantization, or a difference between activation function values.

In an embodiment, the QAT method may further include updating the β to “A(β;π_{Θ})”. The “A(β;π_{Θ})” is updated to “a*(β)”. The “a*(β)” is “a*=argmax_{a∈A} π_{Θ}(a|β, x, s)”.

In an embodiment, the QAT method may further include calculating

$$“ G ( {λ}_{i} , s , x ) = {‖ [ round ( clamp ( \frac{x}{{λ}_{i} s} , l , u ) ) {λ}_{i} s - x ] ‖}_{2} ”$$

with respect to each i∈I, and calculating “i*=argmin_{i∈I} G(λᵢ, s, x)”.

In an embodiment, the set {λᵢ}_{i∈I} is a set “{0.95, 0.96, . . . , 1.04, 1.05}” generated with an interval of 0.01 between 0.95 and 1.05.

According to an embodiment, a program for QAT stored in a non-transitory computer-readable medium, the program, when executed by a processor, causing the processor to perform a method for the QAT. The method includes a setting a quantization level ‘l’ and a quantization level ‘u’ to l=−2^{b-1} and u=2^{b-1}−1, and setting a value ‘k’ to 1, the quantization level ‘l’ being a minimum value of a quantization function, and the quantization level ‘u’ being a maximum value of the quantization function, calculating a quantized value \hat{x} as

$$\hat{x} = round ( clamp ( \frac{x}{s} , l , u ) ) ,$$

the ‘s’ being an initial quantization step, and the ‘x’ being target data to be quantized, performing partial differentiation

$$\frac{\partial L}{\partial \hat{x}}$$

of a loss function ‘L’ with the \hat{x} by using straight-through estimation (STE) for calculating a gradient of a quantization function during backpropagation, calculating

$$\frac{\partial \hat{x}}{\partial s} ,$$

the calculating

$$\frac{\partial \hat{x}}{\partial s}$$

including, when the

$$\frac{x}{s}$$

is a value between the quantization level ‘l’ and the quantization level ‘u’, calculating the

$$\frac{\partial \hat{x}}{\partial s}$$

as

$$- \frac{x}{s} + round ( \frac{x}{s} ) ,$$

and, when the

$$\frac{x}{s}$$

is not a value between the quantization level ‘l’ and the quantization level ‘u’, determining the

$$\frac{\partial \hat{x}}{\partial s}$$

as the quantization level ‘l’ when the

$$\frac{x}{s}$$

is less than ‘l’, and determining

$$\frac{\partial \hat{x}}{\partial s}$$

as the quantization level ‘u’ when the

$$\frac{x}{s}$$

is greater than ‘u’, updating the ‘x’ to

$$x + g ( \begin{matrix}\partial L \\ \partial x\end{matrix} ) ,$$

updating ‘s’ to

$$s + g ( \begin{matrix}\partial L \\ \partial s\end{matrix} ) ,$$

and updating ‘n’ to ‘n+1’, determining whether

$$“ l < \frac{x}{s} < u “$$

is satisfied, and updating a gradient-independent quantization step ‘s’ to s−β(s−sₘᵢₙ) when

$$“ l < \frac{x}{s} < u “$$

is satisfied. An initial value of the β is a hyperparameter, and the β is determined through reinforcement learning. The sₘᵢₙ is a hyperparameter.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1A is a diagram briefly illustrating a basic concept of an ANN;

FIG. 1B is a diagram for describing mapping from a full-precision value to a quantized value;

FIG. 2 is a diagram for describing an update by a gradient descent method and an update including quantization in QAT;

FIG. 3 is a diagram illustrating an update process of an STE;

FIG. 4 is a diagram illustrating a gradient backpropagation process of an STE;

FIG. 5 is a diagram showing a difference between a quantized value, which is a limitation of a conventional QAT technique, and an STE approximated value;

FIG. 6 is a flowchart of learned step size quantization (LSQ) using a conventional STE;

FIG. 7A is a flowchart for describing the entire QAT process including gradient-independent update of a quantization step size, according to an embodiment of the inventive concept;

FIG. 7B shows limitations of LSQ using conventional STE and effects of gradient-independent update of a quantization step size;

FIG. 8 is a diagram showing a first embodiment of a gradient-independent update of a quantization step size, according to an embodiment of the inventive concept; and

FIG. 9 is a diagram showing a second embodiment of a gradient-independent update of a quantization step size, according to an embodiment of the inventive concept.

### DETAILED DESCRIPTION

Hereinafter, various embodiments of the inventive concept may be described with reference to accompanying drawings. However, it should be understood that this is not intended to limit the inventive concept to specific implementation forms and includes various modifications, equivalents, and/or alternatives of embodiments of the disclosure.

In this specification, the singular form of the noun corresponding to an item may include one or more of items, unless interpreted otherwise in context. In this specification, the expressions “A or B”, “at least one of A and B”, “at least one of A or B”, “A, B, or C”, “at least one of A, B, and C”, and “at least one of A, B, or C” may include any and all combinations of one or more of the associated listed items. The terms, such as “first” or “second” may be used to simply distinguish the corresponding component from the other component, but do not limit the corresponding components in other aspects (e.g., importance or order). When a component (e.g., a first component) is referred to as being “coupled with/to” or “connected to” another component (e.g., a second component) with or without the term of “operatively” or “communicatively”, it may mean that a component is connectable to the other component, directly (e.g., by wire), wirelessly, or through the third component.

Each component (e.g., a module or a program) of components described in this specification may include a single entity or a plurality of entities. According to various embodiments, one or more components of the corresponding components or operations may be omitted, or one or more other components or operations may be added. Alternatively or additionally, a plurality of components (e.g., a module or a program) may be integrated into one component. In this case, the integrated component may perform one or more functions of each component of the plurality of components in the manner same as or similar to being performed by the corresponding component of the plurality of components prior to the integration. According to various embodiments, operations executed by modules, programs, or other components may be executed by a successive method, a parallel method, a repeated method, or a heuristic method. Alternatively, at least one or more of the operations may be executed in another order or may be omitted, or one or more operations may be added.

The term “module” used herein may include a unit, which is implemented with hardware, software, or firmware, and may be interchangeably used with the terms “logic”, “logical block”, “part”, or “circuit”. The “module” may be a minimum unit of an integrated part or may be a minimum unit of the part for performing one or more functions or a part thereof. For example, according to an embodiment, the module may be implemented in the form of an application-specific integrated circuit (ASIC).

Various embodiments of the inventive concept may be implemented with software (e.g., a program or an application) including one or more instructions stored in a storage medium (e.g., a memory) readable by a machine. For example, the processor of a machine may call at least one instruction of the stored one or more instructions from a storage medium and then may execute the at least one instruction. This may enable the machine to operate to perform at least one function depending on the called at least one instruction. The one or more instructions may include a code generated by a complier or a code executable by an interpreter. The machine-readable storage medium may be provided in the form of a non-transitory storage medium. Herein, ‘non-transitory’ just means that the storage medium is a tangible device and does not include a signal (e.g., electromagnetic waves), and this term does not distinguish between the case where data is semipermanently stored in the storage medium and the case where the data is stored temporarily.

A method according to various embodiments disclosed in the specification may be provided to be included in a computer program product. The computer program product may be traded between a seller and a buyer as a product. The computer program product may be distributed in the form of a machine-readable storage medium (e.g., compact disc read only memory (CD-ROM)) or may be distributed (e.g., downloaded or uploaded), through an application store, directly between two user devices (e.g., smartphones), or online. In the case of on-line distribution, at least part of the computer program product may be at least temporarily stored in the machine-readable storage medium such as the memory of a manufacturer's server, an application store's server, or a relay server or may be generated temporarily.

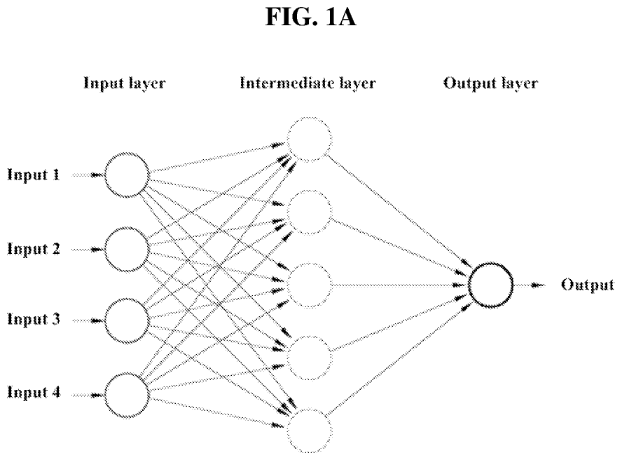

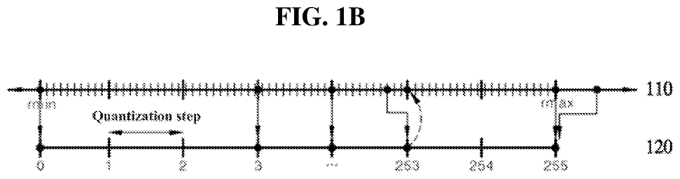

FIG. 1A is a diagram briefly illustrating a basic concept of an artificial neural network (ANN).

As shown in FIG. 1, the ANN may have a hierarchical structure including an input layer, an output layer, and at least one or more intermediate layers (or hidden layers) between the input layer and the output layer. On the basis of a multi-layered structure, the deep learning algorithm may derive highly reliable results through learning to optimize a weight of an interlayer activation function. Here, a process of optimizing the weight includes quantizing a weight value having a real number.

The deep learning algorithm applicable to the inventive concept may include a deep neural network (DNN) such as a convolutional neural network (CNN), a recurrent neural network (RNN), and the like.

The DNN basically improves learning results by increasing the number of intermediate layers (or hidden layers) in a conventional ANN model. For example, the DNN performs a learning process by using two or more intermediate layers.

Accordingly, a computer may derive an optimal output value by repeating a process of generating a classification label by itself, distorting space, and classifying data.

Unlike a technique of performing a learning process by extracting knowledge from existing data, the CNN has a structure in which features of data are extracted and patterns of the features are identified. The CNN may be performed through a convolution process and a pooling process. In other words, the CNN may include an algorithm complexly composed of a convolution layer and a pooling layer. Here, a process of extracting features of data (called a “convolution process”) is performed in the convolution layer. The convolution process may be a process of examining adjacent components of each component in the data, identifying features, and deriving the identified features into one layer, thereby effectively reducing the number of parameters as one compression process. A process of reducing the size of a layer from performing the convolution process (called a “pooling process”) is performed in a pooling layer. The pooling process may reduce the size of data, may cancel noise, and may provide consistent features in a fine portion. For example, the CNN may be used in various fields such as information extraction, sentence classification, and face recognition.

The RNN is a type of artificial neural network specialized in repetitive and sequential data learning, and has a recurrent structure therein. The RNN has a feature that enables a link between present learning and past learning and depends on time, by applying a weight to past learning content by using the circular structure to reflect the applied result to present learning. The RNN may be an algorithm that solves the limitations in learning conventional continuous, repetitive, and sequential data, and may be used to identify speech waveforms or to identify components before and after a text.

For example, when nodes of the input layer and/or the intermediate layer pass to the next step, a value of a node of each layer may be quantized as a value of a weight.

However, these are only examples of specific deep learning techniques applicable to the inventive concept, and other deep learning techniques may be applied to the inventive concept according to an embodiment.

FIG. 1B is a diagram for describing mapping from a full-precision value to a quantized value.

To use a deep learning model in an environment where memory or computing resources are scarce, quantization is a lightweight technique that aims to reduce the memory usage and computational cost of a DNN.

Network quantization aims to reduce the bit-width of network parameters while maintaining the performance of a full-precision network.

Referring to FIG. 1B, consecutive real-number values 110 having a minimum value rmin and a maximum value rmax may be mapped to elements 120 of a set (e.g., 256 in case of 8 bits) having finite size. For example, in a range of real-number values from 0 to 1, when the real-number value is 0.001, the real-number value may be mapped to 0; when the real-number value is 0.501, the real-number value may be mapped to 127; and when the real-number value is 0.999, the real-number value may be mapped to 255. On the other hand, when the real-number value exceeds a given upper limit, the real-number value is mapped to 255, which is the maximum value of an element having a finite set.

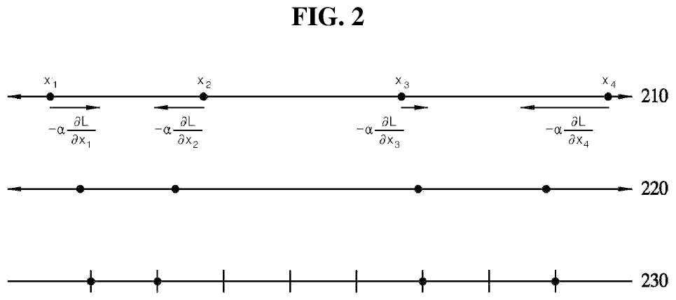

FIG. 2 is a diagram showing an update by a gradient descent method and a subsequent quantization process.

In performing deep learning using various quantization methods, discretizing a weighting activation function value of a network by using a rounding quantizer that simply selects a value close to the value to be quantized is likely to lead to performance degradation. To prevent this issue, the QAT which is a method of training the network while the effect of network quantization is simulated, may be used.

Basically, a deep learning model is trained through the gradient descent method. The gradient descent method is an optimization algorithm that updates a value in an opposite direction of the gradient of an objective function assuming that the objective function is a linear function at every update. However, when the updated result value is simply quantized, it may no longer be an optimal solution. Accordingly, the QAT uses a gradient approximation value capable of considering the quantization effect through fake quantization.

Referring to FIG. 2, at 210, x₁ may be updated by the gradient descent method by moving x₁ in the opposite direction of the gradient

$$- α \frac{\partial L}{\partial {x}_{1}}$$

with respect to x₁ (see a first point moving to the right at “220”). However, when the simply updated x₁ is quantized, a difference between the updated x₁ and the quantized value occurs. Accordingly, the convergence of the optimization algorithm may be hindered, resulting in performance degradation.

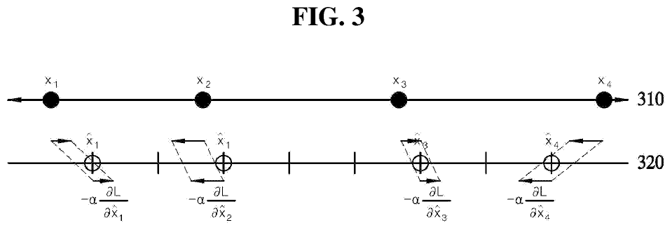

FIG. 3 is a diagram illustrating an update process of an STE.

In this way, learning of DNN can be mainly done through the gradient descent method. However, most quantization functions are in a form (i.e., a function value is a discontinuous value) of a step function, and thus there is a limitation that the gradient descent method is incapable of being applied to the training of a quantized model.

To address the limitation, STE derivative approximation has been proposed (Bengio, Yoshua, Nicholas Leonard, and Aaron Courville. “Estimating or propagating gradients through stochastic neurons for conditional computation.” arXiv preprint arXiv:1308.3432 (2013)). That is, the STE allows non-differentiable quantization functions to backpropagation.

Referring to FIG. 3, a result 320 of performing quantization by using a gradient descent method is shown. For example, during backpropagation, the quantization may be performed by replacing a quantization function with an identity function (y=x).

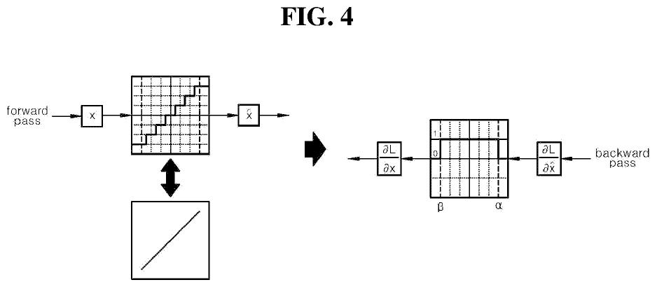

FIG. 4 is a diagram illustrating a backpropagation process of an STE. A STE propagates a gradient by replacing a rounding function used for quantization with an identity function in a backpropagation process. This may train a quantized model with a small additional cost, but it may cause unstable training due to a difference from an actual quantized value.

In detail, with respect to a value between α and β, which are the quantization intervals in the backward pass, a gradient is propagated as it is. In other intervals, 0 is propagated.

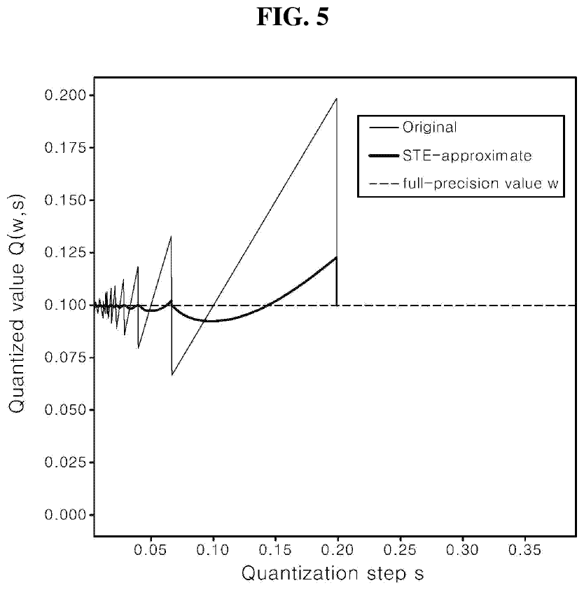

FIG. 5 is a diagram showing a difference between a quantized value, which is a limitation of a conventional QAT technique, and an STE approximated value.

FIG. 5 is a graph of a quantized value Q(w,s) to a quantization step (s) as data for explaining limitations of conventional QAT techniques in a learning quantum step size, and shows a difference between a quantized value and an STE approximated value. In detail, an STE replaces a rounding quantization function with an identity function during backpropagation. Even during forward propagation, a result value (a target to be optimized in the gradient descent method, STE-approximate of FIG. 5) obtained by applying this approximation as it is may differ from a value (original in FIG. 5) that is actually quantized.

To solve this issues, a study (Dohyung Kim, Junghyup Lee, Bumsub Ham, “Distance-aware Quantization.” ICCV 2021) on approximation with a differentiable function in a form similar to the quantized value is proposed. However, training a quantization step size through this gradient-based method fundamentally has the following issues.

As can be seen in FIG. 5, the quantized value is a discontinuous function having a large instantaneous rate of change in the quantization step size. When it is approximated as a differentiable function, it becomes a graph having a lot of curvature, and thus it is difficult for a result updated through a gradient descent method to converge to an optimal solution. Accordingly, conventional QAT methods of approximating a quantization function including the above-mentioned STE to a differentiable function and applying the gradient descent method are valid for training a quantized network of fixed quantization step size, but there is a limit to learning the quantization step size.

In an embodiment of the inventive concept, to supplement a limitation in training a quantization step size of the gradient-based method including an STE, a gradient-independent update method having a quantization step size that is capable of training the gradient-based quantization step size and does not use a gradient capable of supplementing the limitation is proposed.

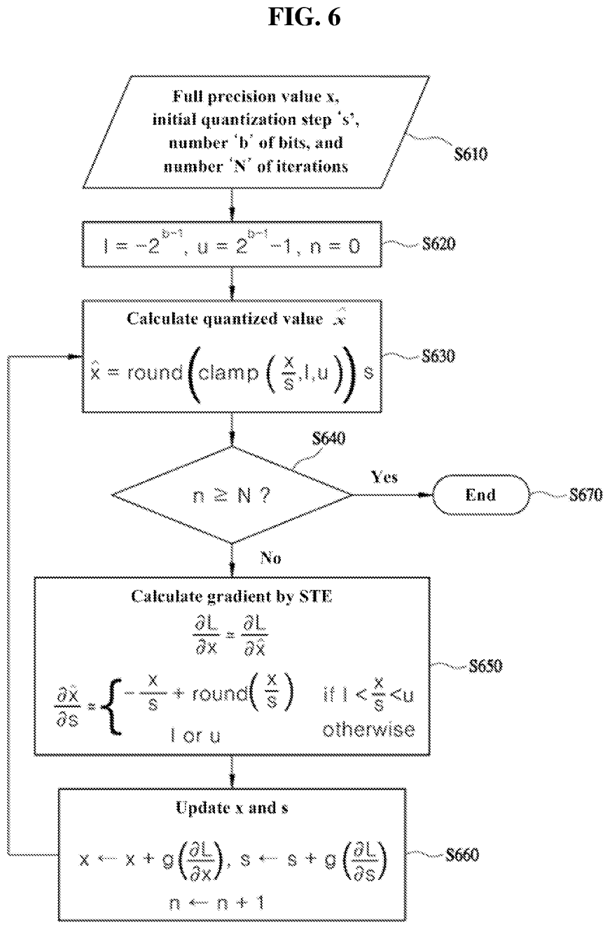

FIG. 6 is a flowchart of learned step size quantization (LSQ) using a conventional STE.

In step S610, target data to be quantized may be set to ‘x’; an initial quantization step may be set to ‘s’; the number of bits may be set to ‘b’; and, the number of iterations may be set to ‘N’.

In step S620, quantization levels ‘l’ and ‘u’ may be set like ‘l’=−2^{b-1} and ‘u’=2^{b-1}. ‘n’ may be set to 0.

In step S630, the quantized value may be calculated as

$$\hat{x} = round ( clamp ( \frac{x}{s} , l , u ) ) .$$

A round function is a function that rounds a number. A clamp function is a function that has an input value, a minimum value, a maximum value as inputs, and ensures that the input value between the maximum value and the minimum value does not exceed a range between the maximum value and the minimum value.

In step S640, a gradient by the STE may be calculated. ‘L’ is a loss function. A value of the partial derivative of L by x may be approximated by a value of the partial derivative of L by \hat{x}. When

$$\frac{x}{s}$$

is a value between ‘l’ and ‘u’,

$$\frac{\partial \hat{x}}{\partial s}$$

(i.e., a value of partial derivative of \hat{x} by s) is calculated as

$$- \begin{matrix}x \\ s\end{matrix} + round ( \begin{matrix}x \\ s\end{matrix} )$$

### by STE. When

$$\frac{x}{s}$$

is a value that is outside the range between ‘l’ and ‘u’, in the case where

$$\frac{x}{s}$$

is less than ‘l’,

$$\frac{\partial \hat{x}}{\partial s}$$

is determined as ‘l’, and in the case where

$$\frac{x}{s}$$

is greater than ‘u’,

$$\frac{\partial \hat{x}}{\partial s}$$

is determined as ‘u’.

$$\frac{\partial L}{\partial x} ≃ \frac{\partial L}{\partial \hat{x}} \qquad [ Equation 1 ]$$

$$\frac{\partial \hat{x}}{\partial s} ≃ \{ \begin{matrix}- \frac{x}{s} + round ( \frac{x}{s} ) if l < \frac{x}{s} < u \\ l or u otherwise\end{matrix}$$

In step S650, x, s, and n may be updated as follows.

$$x ← x + g ( \frac{\partial L}{\partial x} ) , s ← s + g ( \frac{\partial L}{{\partial }_{S}} ) \qquad [ Equation 2 ]$$

$$n ← n + 1$$

In step S660, when ‘n’ is greater than the number of iterations N, the quantization is terminated (S670). In the meantime, when ‘n’ is less than the number of iterations N, the procedure proceeds to step S630.

A summary of the description of the parameters described in FIG. 6 is as follows.

TABLE 2

| | |
|---|---|
| s | Quantization step size |
| l, u | Quantization levels |
| | ‘l’: Minimum value of quantization function |
| | ‘u’: Maximum value of quantization function |
| x | Target data to be quantized |
| \hat{x} | Quantized result |
| g | Update function based on gradient descent method including |
| | a learning rate, “g(v) = −λv”, which has the simplest form, |
| | corresponds to the gradient descent method using |
| | a learning rate ‘λ’. |
| L | Loss function |

The loss function refers to an index by which a neural network is capable of measuring the performance of a weight parameter from training data during training. Training of a deep learning model may refer to finding a weight and a bias for minimizing a function value of the loss function. For example, binary cross entropy, categorical cross entropy, sparse categorical cross entropy, and mean squared error (MSE) may be used as the loss function.

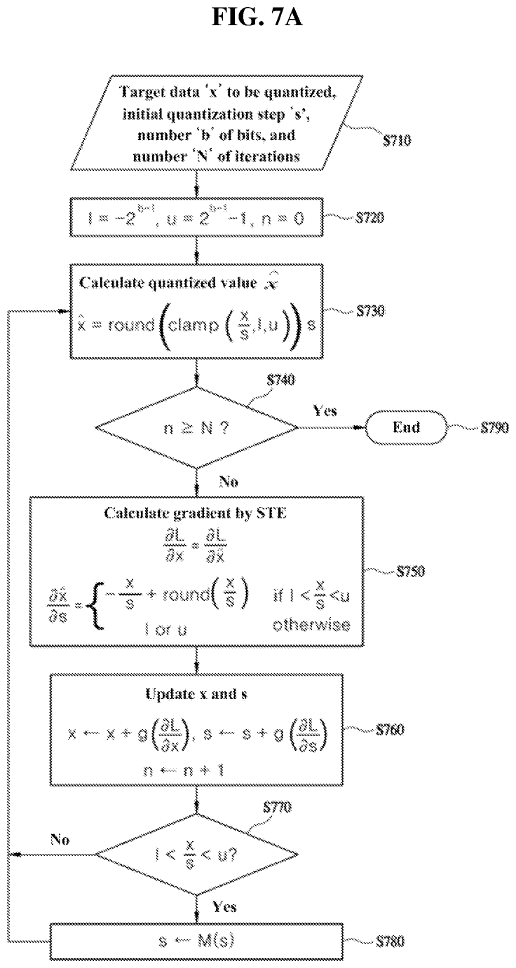

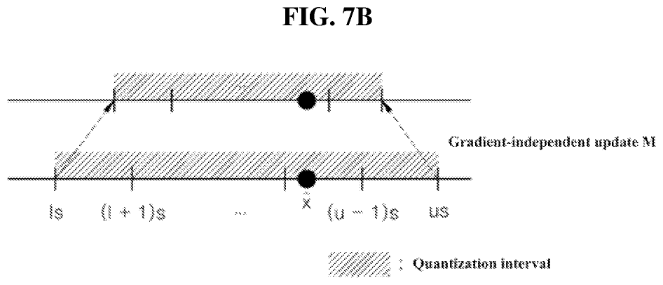

FIG. 7A is a flowchart for describing the entire QAT process including gradient-independent update of a quantization step size, according to an embodiment of the inventive concept.

In addition to limitations of the conventional QAT techniques described in FIG. 5 above, there are the following issues in training the quantization step size through an STE. With respect to the quantization step size, when

$$“ l < \frac{x}{s} < u ”$$

is satisfied, a range of

$$\frac{\partial \hat{x}}{\partial s}$$

is positioned between −0.5 and 0.5 with respect to

$$\frac{\partial \hat{x}}{\partial s}$$

obtained by the STE. On the other hand, in other cases, it has a value of ‘l’ or ‘u, and the latter case tends to lead training (e.g., in case of 8-bit, ‘l’=−128 or ‘u’=127).

In other words, when

$$“ l < \frac{x}{s} < u ”$$

is satisfied once, the update rate of quantization step size may drop significantly. Accordingly, according to an embodiment of the inventive concept, when values to be quantized are included in a quantization interval (when

$$“ l < \frac{x}{s} < u ”$$

is satisfied), a gradient-independent update method M capable of effectively training quantization step size ‘s’ is proposed.

Referring to FIG. 7A, in step S710, target data to be quantized, an initial quantization step, the number of bits, and the number of repetitions may be set.

In step S720, quantization levels ‘l’ and ‘u’ may be set to ‘l’=−2^{b-1} and ‘u’=2^{b-1}, respectively. ‘n’ may be set to 0.

In step S730, the quantized value may be calculated as

$$\hat{x} = round ( clamp ( \frac{x}{s} , l , u ) ) .$$

A round function is a function that rounds a number. A clamp function is a function that has an input value, a minimum value, a maximum value as inputs, and ensures that the input value between the maximum value and the minimum value does not exceed a range between the maximum value and the minimum value.

In step S740, it is determined whether ‘n’ is greater than or equal to the number of iterations N. When ‘n’ is greater than or equal to the number of iterations N, the procedure ends in step S790. When ‘n’ does not exceed the number of iterations N, the procedure proceeds to step S750.

In step S750, a gradient by the STE may be calculated. In step S760, x, s, and n may be updated. Step S750 to step S760 may proceed in the same way as step S650 to step S660 in FIG. 6.

In step S770, it may determine whether

$$“ l < \frac{x}{s} < u ”$$

is satisfied. When

$$“ l < \frac{x}{s} < u ”$$

is satisfied, in step S850, ‘k’ value is updated to “k+1”. In the meantime, when

$$“ l < \frac{x}{s} < u ”$$

is not satisfied, the procedure may return to step S730.

In step S780, ‘s’ value may be calculated through the gradient-independent update method M capable of learning quantization step size ‘s’. Next, the procedure may return to step S730.

FIG. 7B shows limitations of LSQ using conventional STE and effects of gradient-independent update of a quantization step size.

FIG. 7B shows the specific effect. When the target values to be quantized are between quantization levels ‘l’ and ‘s’, a decrease in quantization step size basically leads to accurate quantization. However, when

$$“ l < \frac{x}{s} < u ”$$

is satisfied once in STE-based LSQ, it may not be updated in this way even in a situation where the decrease in quantization step size is required for accurate representation. An additional update method proposed by the inventive concept has been devised to solve the issues.

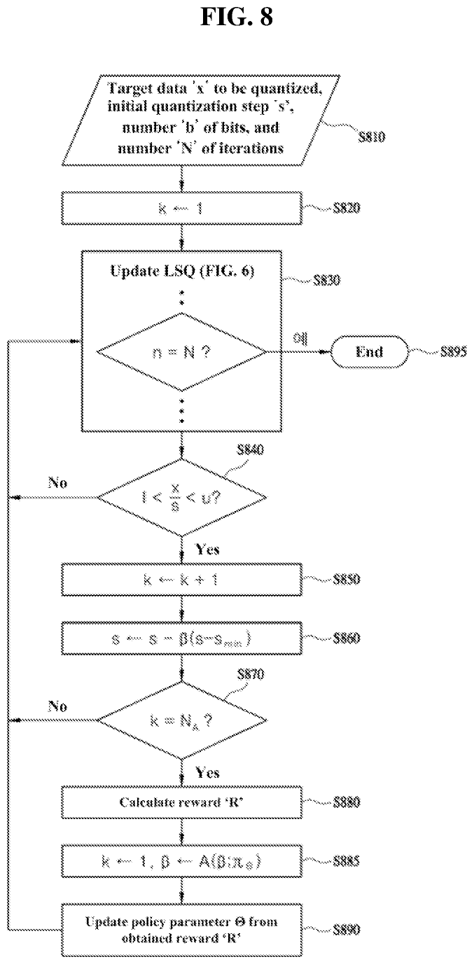

FIG. 8 is a diagram showing a first embodiment of a gradient-independent update of a quantization step size, according to an embodiment of the inventive concept.

This may be a specific embodiment for implementing a gradient-independent update method M capable of learning the quantization step size, and may have the following update form to basically reduce the quantization step size ‘s’.

M₁=s−β(s−sₘᵢₙ),β∈(0,1) [Equation 3]

In the case, value β may be determined by using a hyperparameter determined by a user by using the update as a coefficient, or through reinforcement learning. When the reinforcement learning is used, a state, a selectable action, and a reward are as follows. In the case, an update of actions and policies of the reinforcement learning occurs whenever the quantization step size is updated N_{A} times (a learning hyperparameter and a parameter determined by the user). sₘᵢₙ is a hyperparameter. For example, when activation is quantized, sₘᵢₙ may be a value of 0.001 to 0.1. When a weight value is quantized, sₘᵢₙ may be a value of 0.000001 to 0.0001.

TABLE 3

| | |
|---|---|
| State | Coefficient β, quantizer step size ‘s’, and target data ‘x’ to be |
| | quantized |
| Action | Select maintaining, increasing, and decreasing coefficient β |
| | according to policy π_{Θ} |
| Reward | Value indicating the performance during training using given β |

In the case, an example of set A of selectable actions is proposed as follows.

A={a₁,a₂,a₃}

a₁(β)=max(κ₁,β,βₘᵢₙ),a₂(β)=β,a₃=min(κ₂,β,βₘₐₓ)

In the case, values βₘᵢₙ and βₘₐₓ indicating representing the lower limit and the upper limit of the coefficients K₁ (<1) and K₁ (>1) multiplied by R are determined by the user as hyperparameters.

A policy parameter Θ is trained in a direction in which the performance of a model after quantization is maximized. Accordingly, reward function R may be determined as a value indicating the performance when training is performed by using the given β. For example, reward function R may be defined as a value obtained by multiplying an average of a loss function calculated during N_{A} updates or a difference between values before and after quantization by −1 as follows. As such, the policy parameter Θ is trained in a direction in which the loss function or the difference between values before and after quantization is minimized. The specific expression for the former is as follows.

$$R = - \frac{{\sum }_{k = 1}^{{N}_{A}} L ( {\hat{x}}^{( k )} )}{{N}_{A}} , {\hat{x}}^{( k )} = round ( clamp ( \frac{{x}^{( Κ )}}{{s}^{( Κ )}} , l , u ) ) {s}^{( Κ )} \qquad [ Equation 4 ]$$

In the case, s^{(k)} and x^{(k)} denotes a quantization step size and target data to be quantized at a k-th update, respectively.

An agent A of reinforcement learning determines an action from a state based on the following equation with respect to the policy parameter Θ.

a*=argmax_{a∈A}π_{Θ}(a|β,x,s)

A(β,π_{Θ})=a*(β) [Equation 5]

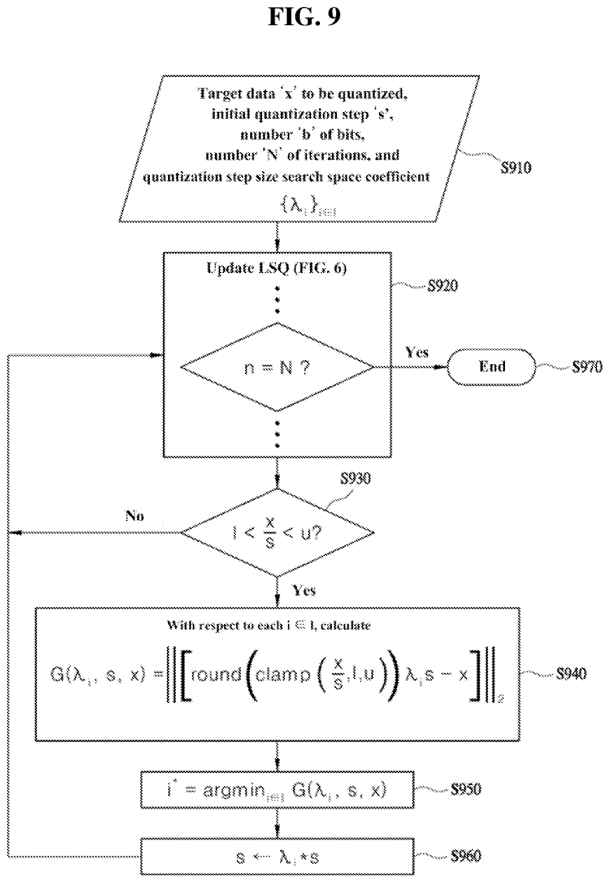

FIG. 9 is a diagram showing a second embodiment of a gradient-independent update of a quantization step size, according to an embodiment of the inventive concept.

As a specific embodiment for implementing M method, the following update types are provided for the purpose of basically reducing the quantization step size ‘s’.

M₁(s)=λᵢ·s [Equation 6]

i*=argmin_{i∈I}(G(λᵢ,s,x)) [Equation 7]

Referring to FIG. 8, in step S810, target data to be quantized, an initial quantization step, the number of bits, the number of repetitions, the number of iterations between actions, and the policy parameter Θ may be set.

In step S820, ‘k’ may be initialized to 1.

In step S830, an LSQ may be updated. In this process, step S620 to step S660 in FIG. 6 may be included.

In step S840, it may determine whether

$$“ l < \frac{x}{s} < u ”$$

is satisfied. When

$$“ l < \frac{x}{s} < u ”$$

is satisfied, in step S850, ‘k’ value is updated to “k+1”. In the meantime, when

$$“ l < \frac{x}{s} < u ”$$

is not satisfied, the procedure may return to step S830. After value ‘k’ is updated to “k+1”, in step S860, value ‘s’ may be updated to “s−β(s−sₘᵢₙ)”. As described above, value β may be determined by using a hyperparameter determined by a user by using the update as a coefficient, or through reinforcement learning.

In step S870, it is determined whether value ‘k’ is equal to value N_{A}. Here, N_{A} may be determined by the user as a learning hyperparameter. In step S880, reward function ‘R’ and set “k←1, β←A(β;π_{θ})” may be calculated. Here, whenever the quantization step size is updated N_{A} times, ‘k’ is initialized to 1.

In step S890, the policy parameter Θ may be updated from the obtained reward function R. Afterward, the procedure may return to step S830.

Referring to FIG. 9, in step S910, target data to be quantized, an initial quantization step, the number of bits, the number of repetitions, and a quantization step size search space coefficient {è}(∈) may be set.

In step S920, an LSQ may be updated. In this process, step S620 to step S660 in FIG. 6 may be included.

In step S930, it may determine whether

$$“ l < \frac{x}{s} < u ”$$

is satisfied. When

$$l < \frac{x}{s} < u$$

is satisfied, in step S940,

$$“ G ( {λ}_{i} , s , x ) = {‖ [ round ( clamp ( \frac{x}{{λ}_{i} s} , l , u ) ) {λ}_{i} s - x ] ‖}_{2} ”$$

may be calculated with respect to each i∈1.

In step S950, “i*=argmin_{i∈I} G(λᵢ, s, x)” may be calculated. Here, the argmin function is a function of returning an index for minimizing a function value. In an embodiment, ‘s’ and ‘x’ are given in “i*=argnin_{i∈I} G(λᵢ, s, x)”, “G(λᵢ, s, x)” is calculated for each i belonging to set ‘l’. The smallest value ‘i’ is returned.

In step S960, ‘s’ may be determined as “λᵢ*s”. Next, the procedure may return to step S920.

In step S920, when ‘n’ equals ‘N’, the quantization method ends (S970).

In the case, {λᵢ}_{i∈I} is the set of real numbers close to 1, and is a coefficient used to search for peripheral values of a given quantization step size. For example, a set (i.e., {0.95, 0.96, . . . , 1.04, 1.05}) generated with an interval of 0.01 between 0.95 and 1.05 may be used as set “{λᵢ}_{i∈I}”. Moreover, Function G may be an objective function for determining the quantization step size, and may be (1) a difference in value before and after quantization, (2) a difference between output values of the corresponding layer or the final layer before and after quantization, (3) a loss function value after quantization, or the like. Basically, limitations of gradient-based update may be supplemented by selecting a value for minimizing accuracy or performance loss due to quantization among peripheral values of a given quantization step size.

Additionally, a computer program according to an embodiment of the inventive concept may be stored in a computer-readable recording medium to execute various methods described above while being combined with a computer.

The above-described program may include a code encoded by using a computer language such as C, C++, JAVA, a machine language, or the like, which a processor (CPU) of the computer may read through the device interface of the computer, such that the computer reads the program and performs the methods implemented with the program. The code may include a functional code related to a function that defines necessary functions executing the method, and the functions may include an execution procedure related control code necessary for the processor of the computer to execute the functions in its procedures. Furthermore, the code may further include a memory reference related code on which location (address) of an internal or external memory of the computer should be referenced by the media or additional information necessary for the processor of the computer to execute the functions. Further, when the processor of the computer is required to perform communication with another computer or a server in a remote site to allow the processor of the computer to execute the functions, the code may further include a communication related code on how the processor of the computer executes communication with another computer or the server or which information or medium should be transmitted/received during communication by using a communication module of the computer.

Steps or operations of the method or algorithm described with regard to an embodiment of the inventive concept may be implemented directly in hardware, may be implemented with a software module executable by hardware, or may be implemented by a combination thereof. The software module may reside in a random access memory (RAM), a read only memory (ROM), an erasable programmable ROM (EPROM), an electrically erasable programmable ROM (EEPROM), a flash memory, a hard disk, a removable disk, a CD-ROM, or a computer-readable recording medium well known in the art to which the inventive concept pertains.

Hereinabove, the above description is merely illustrative of the technical idea disclosed in the specification, and various modifications and variations may be made by one skilled in the art, to which the embodiments disclosed in the specification belong, without departing from the essential characteristic of the embodiments disclosed in the specification. Therefore, embodiments disclosed in the specification are intended not to limit but to explain the technical idea disclosed in the specification, and the scope of the technical idea disclosed in the specification is not limited by this embodiment. The scope of protection disclosed in the specification should be construed by the attached claims, and all equivalents thereof should be construed as being included within the scope of the specification.

According to an embodiment of the inventive concept, costs required for QAT may be reduced and the performance of the quantized network may be improved by learning a quantization step accurately and quickly.

According to an embodiment of the inventive concept, even in an environment where memory or computing resources are scarce, the use of deep learning models may be facilitated by training a low-bit network that maintains the performance of a full-precision network.

Moreover, the utilization of NPU dedicated to deep learning model may be increased, and a deep learning model may be mounted on an edge device that requires low power.

While the inventive concept has been described with reference to embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A quantization-aware training (QAT) method comprising:
setting a quantization level ‘l’ and a quantization level ‘u’ to l=−2^{b-1} and u=2^{b-1}−2-1, and setting a value ‘k’ to 1, wherein the quantization level ‘l’ is a minimum value of a quantization function, and the quantization level ‘u’ is a maximum value of the quantization function;
calculating a quantized value \hat{x} as
$$\hat{x} = round ( clamp ( \frac{x}{s} , l , u ) ) ,$$
wherein the ‘s’ is an initial quantization step, and the ‘x’ is target data to be quantized;
performing partial differentiation
$$\frac{\partial L}{\partial \hat{x}}$$
of a loss function ‘L’ with the \hat{x} by using straight-through estimation (STE) for calculating a gradient of a quantization function during backpropagation;
calculating
$$\frac{\partial \hat{x}}{\partial s} ,$$
wherein the calculating
$$\frac{\partial \hat{x}}{\partial s}$$
includes:
when the
$$\frac{x}{s}$$
is a value between the quantization level ‘l’ and the quantization level ‘u’, calculating the
$$\frac{\partial \hat{x}}{\partial s}$$
as
$$- \frac{x}{s} + round ( \frac{x}{s} ) ;$$
and
when the
$$\frac{x}{s}$$
is not a value between the quantization level ‘l’ and the quantization level ‘u’, determining the as
$$\frac{\partial \hat{x}}{\partial s}$$
as the quantization level ‘l’ when the
$$\frac{x}{s}$$
is less than ‘l’, and determining
$$\frac{\partial \hat{x}}{\partial s}$$
as the quantization level ‘u’ when the
$$\frac{x}{s}$$
is greater than ‘u’;
updating the ‘x’ to
$$x + g ( \begin{matrix}\partial L \\ \partial x\end{matrix} ) ,$$
updating ‘s’ to
$$s + g ( \begin{matrix}\partial L \\ \partial s\end{matrix} ) ,$$
and updating ‘n’ to ‘n+1’;
determining whether
$$“ l < \frac{x}{s} < u ”$$
is satisfied; and
when
$$“ l < \frac{x}{s} < u ”$$
is satisfied, updating a gradient-independent quantization step ‘s’ to “s−β(s−sₘᵢₙ)”,
wherein an initial value of the β is a hyperparameter, and the β is determined by using the initial value or through reinforcement learning, and
wherein the sₘᵢₙ is a hyperparameter.

2. The QAT method of claim 1, further comprising:
determining whether the value ‘k’ is equal to a value Nₐ, wherein the Nₐ is a learning hyperparameter;
calculating a reward function ‘R’; and
initializing the ‘k’ to 1,
wherein the reward function ‘R’ is determined to represent performance when learning is performed by using the β, and
wherein the reward function ‘R’ is defined as an average of the loss function ‘L’ calculated during Nₐ updates, a difference between weights before and after quantization, or a difference between activation function values.

3. The QAT method of claim 2, further comprising:
updating the β to “A(β;π_{Θ})”,
wherein the “A(β;π_{Θ})” is updated to “a*(β)”, and
wherein the “a*(β)” is “a*=argmax_{a∈A}π_{Θ}(a|β, x, s)”.

4. The QAT method of claim 3, further comprising:
calculating
$$“ G ( {λ}_{i} , s , x ) = {‖ [ round ( clamp ( \frac{x}{{λ}_{i} s} , l , u ) ) {λ}_{i} s - x ] ‖}_{2} ”$$
with respect to each i∈1; and
calculating “i*=argmin_{i∈I}G(λᵢ, s, x)”.

5. The QAT method of claim 4, wherein the set {λᵢ}_{i∈I} is a set “{0.95, 0.96, . . . , 1.04, 1.05}” generated with an interval of 0.01 between 0.95 and 1.05.

6. A program for QAT stored in a non-transitory computer-readable medium, wherein the program, when executed by a processor, causes the processor to perform a method for the QAT,
wherein the method including:
setting a quantization level ‘l’ and a quantization level ‘u’ to l=−2^{b-1} and u=2^{b-1}, and setting a value ‘k’ to 1, wherein the quantization level ‘l’ is a minimum value of a quantization function, and the quantization level ‘u’ is a maximum value of the quantization function;
calculating a quantized value \hat{x} as
$$\hat{x} = round ( clamp ( \frac{x}{s} , l , u ) ) ,$$
wherein the ‘s’ is an initial quantization step, and the ‘x’ is target data to be quantized;
performing partial differentiation
$$\frac{\partial L}{\partial \hat{x}}$$
of a loss function ‘L’ with the \hat{x} by using straight-through estimation (STE) for calculating a gradient of a quantization function during backpropagation;
calculating
$$\frac{\partial \hat{x}}{\partial s} ,$$
wherein the calculating
$$\frac{\partial \hat{x}}{\partial s}$$
includes:
when the
$$\frac{x}{s}$$
is a value between the quantization level ‘l’ and the quantization level ‘u’, calculating the
$$\frac{\partial \hat{x}}{\partial s}$$
as
$$- \frac{x}{s} + round ( \frac{x}{s} ) ;$$
and
when the
$$\frac{x}{s}$$
is not a value between the quantization level ‘l’ and the quantization level ‘u’, determining the
$$\frac{\partial \hat{x}}{\partial s}$$
as the quantization level ‘l’ when the
$$\frac{x}{s}$$
is less than ‘l’, and determining
$$\frac{\partial \hat{x}}{\partial s}$$
as the quantization level ‘u’ when the
$$\frac{x}{s}$$
is greater than ‘u’;
updating the ‘x’ to
$$x + g ( \begin{matrix}\partial L \\ \partial x\end{matrix} ) ,$$
updating ‘s’ to
$$s + g ( \begin{matrix}\partial L \\ \partial x\end{matrix} ) ,$$
and updating ‘n’ to ‘n+1’;
determining whether
$$“ l < \frac{x}{s} < u ”$$
is satisfied; and
when
$$“ l < \frac{x}{s} < u ”$$
is satisfied, updating a gradient-independent quantization step ‘s’ to “s−β(s−sₘᵢₙ)”,
wherein an initial value of the β is a hyperparameter, and the β is determined by using the initial value or through reinforcement learning, and
wherein the sₘᵢₙ is a hyperparameter.

7. The program of claim 6, further comprising:
determining whether the value ‘k’ is equal to a value Nₐ, wherein the Nₐ is a learning hyperparameter;
calculating a reward function ‘R’; and
initializing the ‘k’ to 1,
wherein the reward function ‘R’ is determined to represent performance when learning is performed by using the β, and
wherein the reward function ‘R’ is defined as an average of the loss function ‘L’ calculated during Nₐ updates, a difference between weights before and after quantization, or a difference between activation function values.

8. The program of claim 6, further comprising:
updating the β to “A(β;π_{Θ})”,
wherein the “A(β;π_{Θ})” is updated to “a*(β)”, and
wherein the “a*(β)” is “a*=argmax_{a∈A} π_{Θ}(a|β, x, s)”.

9. The program of claim 8, further comprising:
calculating
$$“ G ( {λ}_{i} , s , x ) = {‖ [ round ( clamp ( \frac{x}{{λ}_{i} s} , l , u ) ) {λ}_{1} s - x ] ‖}_{2} “$$
with respect to each i∈I; and
calculating “i*=argmin_{i∈I} G(λᵢ, s, x)”.

10. The program of claim 6, wherein the set {λᵢ}_{i∈I} is a set “{0.95, 0.96, . . . , 1.04, 1.05}” generated with an interval of 0.01 between 0.95 and 1.05.
